(19) United States
(12) Patent Application Publication
(10) Pub. No.: US 2018/0328601 A1
(43) Pub. Date: Nov. 15, 2018

(54) HEAT RECOVERY ADSORBER AS VENTILATION SYSTEM IN BUILDINGS

(71) Applicant: BASF SE, Ludwigshafen am Rhein (DE)

(72) Inventors: Matthias WEICKERT, Ludwigshafen (DE); Stefan MARX, Ludwigshafen (DE); Ulrich MÜLLER, Ludwigshafen (DE); Lena ARNOLD, Ludwigshafen (DE)

(21) Appl. No.: 15/775,657

(22) PCT Filed: Nov. 15, 2016
(86) PCT No.: PCT/EP2016/077695

§ 371 Date: May 11, 2018

(30) Foreign Application Priority Data
Nov. 18, 2015 (EP) 15195166.2

(51) Int. Cl. F24F 3/14; F24F 12/00; B01D 53/26

(52) U.S. Cl. CPC F24F 3/1411; F24F 12/006; B01D 53/261; B01D 2253/104; B01D 2253/204; B01D 2253/108; B01D 2253/342

(57) ABSTRACT

The invention relates to a ventilation system (10) with heat recovery adsorber, the ventilation system (10) for being installed in buildings, wherein the ventilation system (10) furthermore comprises at least one exterior intake/outlet opening (11) for an air stream from outside of the building and at least one interior intake/outlet opening (23) for an air stream from inside the building, at least one air fan unit (14) and at least one filter unit (12, 22), wherein the heat recovery adsorber includes a heat exchange material (16) for absorbing and releasing heat from the air streams and a sorption material (18) for at least adsorbing and desorbing at least one sorbate from the air streams, wherein the at least one sorbate is water vapor, said sorption material (18) comprising at least one adsorbent for water vapor exhibiting an s-shaped water adsorption isotherm (30) at room temperature (25° C.+/−10° C.) with a steep increase in a narrow relative humidity range, wherein a main loading lift of the adsorbent for water vapor occurs in the relative humidity range from 0.1 to 0.5 and the saturation capacity of the adsorbent for water vapor lies in the range from 0.25 to 1.2 kg_{water}/kg_{adsorbent}. The invention further relates to methods and uses for combined heat recovery, cooling/heating and dehumidifying/humidifying of air streams for buildings as well as such buildings.

The invention relates to a ventilation system for being installed in buildings, comprising a heat recovery adsorber for heat recovery, humidification and/or dehumidification, heating and/or cooling air in buildings like residential, commercial and industrial buildings. Furthermore, the invention relates to methods and uses for combined heat recovery, cooling/heating and dehumidifying/humidifying for buildings as well as such buildings.

The global contribution from buildings towards energy consumption, both residential and commercial, has steadily increased reaching figures between 20% and 40% in developed countries. Estimated up to 50% of the energy consumption for buildings could be saved. But making the building envelope air tight, ventilation systems must be provided to generate an agreeable indoor climate. As many buildings are heated to temperatures above outside temperature, ventilation systems can be the source of significant heat loss. When ventilation systems are provided by a mechanical supply and exhaust system, the energy efficiency of ventilation has to be further improved through heat recovery from exhaust air, demand-controlled ventilation, depending on occupancy, moisture and air quality factors.

Building standards are placing increased importance on achieving comfortable and healthy indoor living conditions requiring air filtration for purifying incoming outdoor air from dust, pollutant, even odors and control of the humidity to maintain a healthful, comfortable environment. Ventilation is intended to remove or dilute pollutants and to control the thermal environment and humidity in buildings. It is an aim either to remove pollutants and humidity generated indoors or to dilute their concentrations to acceptable levels. Also heating and cooling of intake air can easily be combined with ventilation, it is still difficult to recover heat from exhaust air and to use the recovered heat to heat incoming ventilation air.

In known ventilation systems exhaust air flow through air-to-air heat exchanger, designed as cross flow or counterflow heat exchanger, before it is discharged outdoors. Said heat exchanger has been constructed from metals and from certain ceramics such as aluminum oxide and silicon carbide. Such materials, while structurally sound, are expensive and have no or little capability of storing and releasing moisture and requiring high maintenance. Furthermore, air intake and discharge openings have to be carefully arranged to minimize bypass. Other known ventilation systems include an apparatus for transferring heat and moisture between the exhaust air and the supply air wherein heat and/or moisture is adsorbed and desorbed into at least one adsorptive structure.

U.S. Pat. No. 4,952,283 relates to an apparatus for ventilation, recovery of heat, dehumidification and cooling of air wherein the apparatus is used inter glia in comfort-to-comfort moisture and/or heat transfer applications, where heat and/or moisture is transferred between exhaust air and supply air streams. Moisture and/or heat is transferred between the two air streams by first absorbing heat and/or moisture from the first hot and/or moist air stream into a porous matrix of a suitable solid material during the first, i.e. sorption, period, and then by releasing the heat and/or moisture from the matrix into a further, relatively cool and/or dry air stream during a second, i.e. desorption, period. Furthermore, the application provides a valveless periodic flow type apparatus in which the countercurrent flow of the two air streams is achieved by a reversing air fan.

U.S. Pat. No. 4,708,000 A describes an apparatus for cyclic countercurrent transfer of heat and mass for use in air conditioning applications. The compact apparatus comprises two treatment vessels, each containing a compact packed bed of solid sorbent material, a heater and consecutive a solid heat exchanging material, wherein a recovery of the released sorption heat and the use of the sorption heat in reactivation of the sorbent material is provided. The heat exchanging material is ceramic, stone or fired clay gravel or pebbles or fired pellets. The solid sorbent material is any commercially available adsorbents such as lithium chloride or lithium bromide, increasing the effectiveness in transferring the sensible and latent heat and moisture between the two air streams.

Aristov, Yu. A., Mezentsev, I. V. and Mukhin, V. A. 2006, A New Approach to Heat and Moisture Regeneration in the Ventilation System of Rooms. II. Prototype of the Real Device, J. of Eng. Physics and Thermodynamics, Vol. 79, No. 3, 577-584, describes a ventilation system for rooms with heat and moisture regeneration wherein the heat and moisture recovery coefficients are regulated over a wide range by selecting the quantity of the adsorbent and heat-accumulating medium. According to the authors it turned out that the adsorbent acts as an additional heat-accumulating medium and that the size of the adsorbent has an effect on the duration of the working cycle.

EP 1 840 486 A1 relates to a heat exchange module of a sorptive type wherein humidity control is carried out by adsorption and desorption of water vapor using a sorptive agent of an organic polymer type and heat generation and cooling caused by such an adsorption and desorption are utilized through metal having an excellent heat conductivity, whereon the moisture adsorptive layer is formed. A moisture adsorptive layer in which a sorptive agent is an essential component, showing saturated moisture adsorbing rates at 20° C. and 65% RH (relative humidity) and 90% RH are not less than 20% by weight and not less than 40% by weight, respectively and the difference in the saturated moisture adsorbing rates under such a condition is not less than 20% by weight.

In buildings a ventilation system with mechanical supply and exhaust system can be centralized or decentralized. In decentralized ventilation systems more components require maintenance and are widely spread out, but ventilation is easier to control by demand. In decentralized systems a periodic operation mode preferably comprises an air intake period followed by a discharge period with duration time of air intake period being equal to duration time of the discharge period. The duration time is between 60 and 120 s.

In centralized ventilation systems the intake and outlet or discharge openings are easier to arrange at the building envelope but the ductwork systems are highly complicated. In general the ventilation rate provided by the ventilation system should be energy efficient and arranged so that it does not degrade indoor air quality or climate.

Survey of the prior art ventilation systems indicates, that the current ventilation systems with heat recovery adsorber are not capable of simultaneous heat recovery, controlling the humidity, filtration of odors, purifying the air and reducing noise. Despite numerous adsorption cooling/heating modules provided in ventilation systems known in the prior art, there is a need for alternative ventilation systems with a heat recovery adsorber in which further to heat recovery a humidity regulation is carried out by means of dehumidification and humidification by adsorption and desorption of water vapor using at least a sorption material and in which means of sound-absorbing and filtration are provided.

Accordingly an object of the present invention is to provide a ventilation system which prevents at least partly the above disadvantages.

The object is achieved by a ventilation system with heat recovery adsorber for buildings, wherein the ventilation system being installed in buildings and wherein the ventilation system furthermore comprises at least one exterior intake/outlet opening for an air stream from outside of the building and at least one interior intake/outlet opening for an air stream from inside the building, at least one air fan unit and at least one filter unit. The heat recovery adsorber includes a heat exchange material for absorbing and releasing heat from the air streams. For example between an air intake stream and an air discharge stream heat from warm exhaust air is transferred to cool incoming air. Furthermore, the heat recovery adsorber includes a sorption material for at least adsorbing and desorbing at least one sorbate from the air streams, wherein the at least one sorbate is water vapor. Said sorption material comprises at least one adsorbent for water vapor exhibiting an s-shaped water adsorption isotherm at room temperature (25° C.+/−10° C.) with a steep increase in a narrow relative humidity range, wherein a main loading lift of the adsorbent for water vapor occurs in the relative humidity range from 0.1 to 0.5 and the saturation capacity for the adsorbent for water vapor lies in the range from 0.25 to 1.2 kg_{water}/kg_{adsorbent}.

In a preferred embodiment the adsorbent for water vapor shows a steep increase in the relative humidity range from 0.15 to 0.4. The loading lift is at least 65% of the total loading, preferably in the range of 80% to 95%. Preferably, the saturation capacity of the adsorbent for water vapor lies in the range from 0.3 to 0.6 kg_{water}/kg_{adsorbent}.

The ventilation system comprises at least one air fan unit in order to flow air streams, i.e. said air intake stream and said air outlet stream, into the ventilation system, at least one filter unit for removing particulate matters and various gases from said air streams wherein air supplied for ventilation is cleaned of outdoor air pollutants and odors. Preferably, a sound-absorbing sorbent for reducing the noise of the at least one air filter unit and/or outdoor noise can be provided.

Said components are combined to the ventilation system and are adapted depending on the ventilation system, i.e. whether it is a centralized or decentralized system.

Energy-conserving buildings require the careful maintenance of good indoor air quality through maintaining, among other factors, optimum relative humidity levels. These optimum relative humidity levels vary on the seasons of the year slightly, but should be kept above 30% to 40% and not more than 60%. The humidity of air outside of buildings relates on the conditions of the weather, i.e. temperature, atmosphere pressure etc. But the humidity of air inside of buildings has different sources like breathing of human and animal beings, transpiration of plants, evaporation of water from other sources, related to drying laundry and cooking. In order to solve the problems related to humidity regulation, known methods are based on engineering principles of the unit operation of sorption which is well known and documented and the operation is effectively used in many applications involving recovery of solvents, separation of petrochemicals, separation of oxygen and nitrogen from air, removing toxic gases from steam gases and removing moisture from liquid and gaseous products.

Sorption, covering adsorption and absorption, is an exothermic process. Adsorption describes the attachment of atoms or molecules of a gaseous or liquid fluid onto the surface of a solid material, which is also referred to as adsorbent medium, adsorbent, adsorber, absorber or sorbent. In turn, desorption is an endothermic process. It is known that the amount of moisture removed from air by adsorption depends on properties of the adsorbent, on the temperature of the adsorbent during adsorption, on the temperature, pressure and humidity of the treated air and on the contact time of the treated air with the adsorbent.

According to the present invention effecting the humidity or moisture of the indoor air the sorption material comprises at least one adsorbent for water vapor which is also referred as sorbent or absorbent, wherein said at least one adsorbent for water vapor shows suitable equilibrium sorption characteristics. Depending on the boundary conditions given by the application, adsorption-desorption must take place at appropriate relative pressures p/p₀ also expressed as relative humidity. Thus, the adsorbent for water vapor according to the present invention is characterized by water adsorption isotherms showing a favorable s-shape with a steep increase in a narrow relative pressure range, respectively a narrow range of relative humidity.

An adsorption isotherm of the adsorbent for water vapor at a temperature range of room temperature 25° C.+/−10° C. shows no or low adsorption (preferably less than 0.10 kg_{water}/kg_{adsorbent}) in the relative humidity range of approximately <0.1, preferably <0.15. For relative humidity in the range from 0.1 to 0.5, preferable from 0.15 to 0.4, a steep increase of the adsorption isotherm indicates main loading lift of the adsorbent for water vapor, wherein water adsorption isotherm reaches a second section, wherein adsorption is much lesser pronounced. The second section, starting in the relative humidity range approximately >0.5 to 1.0, preferably >0.4, indicates less adsorption (0.05 to 0.15 kg_{water}/kg_{adsorbent}). Water vapor uptakes, also described as saturation capacity or total loading, are in the range of 0.25 to even 1.2 kg_{water}/kg_{adsorbent} at 100% humidity, preferably in the range from 0.3 to 0.6 kg_{water}/kg_{adsorbent} and more preferably in the range from 0.45 to 0.55 kg_{water}/kg_{adsorbent}.

Preferably, adsorption isotherms of preferred adsorbents for water vapor show for higher temperatures comparable s-shape with a steep increase of the adsorption in a narrow humidity range. The steep increase of adsorption is shifted towards higher relative humidity range, for example at 333 K the adsorbent for water vapor of a MOF type may show the steep increase of adsorption in the relative humidity range approximately from 0.3 to 0.5, wherein the saturation capacity remains nearly unchanged.

Furthermore, in regard of the application as heat recovery adsorber in ventilation systems, where unhindered heat and mass transfer are crucial for fast ad-/desorption cycles, beside the water adsorption isotherm and the saturation adsorption capacity, the kinetics are significant for fast cyclic adsorption processes. The duration of the cycles, i.e. the time between the reversals of the air-flow direction depends on the kinetics, the quantity of the sorption material and the heat exchange material, as well as on the degree of heat and moisture regeneration.

Preferred adsorbents for water vapor show a high selectivity to adsorb polar vapor molecules from gases, such as water and to a lesser extend for example to CO₂. The ability to adsorb water vapor of humid air is provided by materials such as silica gels, activated alumina, activated bauxite, molecular sieves and metal-organic frameworks (MOFs). MOFs can surpass classical materials like silica gels or zeoliths in terms of saturation capacities. MOFs are being increasingly investigated for the purposes of adsorption of water vapor because of their high porosity, tunable hydrophobicity and inherent, narrow pore size distributions which result in a sharp loading step. MOFs can be visualized as a series of joints (metal cluster) and struts (organic linkers) that form an extended, porous network. In contrast to other adsorbents for water vapor MOFs typically exhibit s-shaped water adsorption isotherms. MOFs are tailorable, including a plurality of metal atoms coordinated to a plurality of organic spacer molecules, wherein the MOF is coupled to at least one surface of the substrate and wherein the MOF is adapted to adsorption and desorption of moisture from the air, pollutants and odor and may act additionally as a filter. In especially, microporous aluminum fumarate MOF, commercially available as BASOLITE® A520, shows distinctive water sorption properties, can be easily prepared from inexpensive reagents and has sufficient water stability.

Metal-organic frameworks (MOFs) are known in the prior art and are described in U.S. Pat. No. 5,648,508.

The core component of the heat recovery adsorber of the ventilation system is the sorption material. The sorption material can be provided as pulverulent material, granulates, shaped bodies or monoliths and can be arranged for example in a casing as a matrix or a filling such as a packed bed or a moving bed. Preferred are monoliths, wherein monolithic structures may be such as blocks or cylinders, when used as filling or matrix. Shaped, respectively monolithic bodies can be handled more conveniently and especially in a safer manner, since abrasion is reduced and the mechanical stability is higher. The length/height of the filling or matrix in the casing is selected to provide minimal pressure drop for the flow of the air streams.

The sorption material can be monofunctional or multifunctional. The sorption material can comprise beside the adsorbent for water vapor further sorbents, for example sound-absorbing material/sorbent and/or sorbents for other components such as toxic components, pollutants etc.

Sorption material is typically not used as a powder, but is preferably shaped or be fabricated into a device. Preferably, metal-organic frameworks (MOFs) are provided in monolithic form with high permeability, wherein flow channels for the air streams has diameters between 1 to 3 mm, providing a free cross-section area of the monolithic form in the range of 70% to 90% of the total cross-section area.

The ventilation system may be installed as a decentralized unit, preferably installed in separated rooms of the building or as a centralized unit, installed in the building, wherein air from inside of the building is led to the interior intake/outlet opening and the exterior intake/outlet opening is arranged on an envelope of the building. The quantity of the adsorbent for water vapor in the ventilation system depends whether it is used in a central or decentral ventilation system. In decentralized ventilation systems provided for ventilation of a space with approximately 30 m² the mass flow per operation period is up to 1 kg of air, whereby in summer the humidity of the incoming air is reduced from 80% to 35%, this means 8 to 12 g_{water}/m³ has to be adsorbed. With this data the mass of the adsorbent for water vapor MOF, i.e. BASOLITE® A520, is calculated to be approximately 0.1 to 0.2 kg, providing a height of the filling in an appropriate casing in the range of approximately 50 to 100 mm. In regard of a centralized ventilation system for a building with 15 rooms the mass of the adsorbent for water vapor MOF, i.e. BASOLITE® A520, is approximately 3 kg, providing a height of the filling in the casing in the range of approximately 300 to 700 mm.

In a preferred embodiment of the present invention the sorption material is deposited as a coating on a substrate. The sorption material can be coated with or without using binders. The substrate is preferably made of ceramic, metal, plastic, foam based on polyurethane, polypropylene, polyester, metal or ceramic, woven or non-woven fibers of plastic, cellulose or mixtures thereof. If the substrate may function as heat adsorber, it can be a film, a monolithic structure made of ceramic, metal or preferably a sorbent. The substrate may be provided as a monolithic structure or is provided as spherical, cylindrical or cubic pellets in the dimension in the range of 1 to 3 mm. If the substrate may function as damper, it can be made of plastic, foam based on polyurethane, polypropylene, polyester, metal or ceramic, woven or non-woven fibers of plastic or cellulose, wherein the substrate may be provided as a monolithic structure, powder or filling of spherical, cylindrical or cubic pellets in a dimension in the range of 1 to 3 mm.

In a preferred embodiment of the invention the sorption material is a metal-organic framework (MOF), preferably as aluminum fumarate MOF.

Another core component of the ventilation system with a heat recovery adsorber is the heat exchange material. Preferably the heat exchange material comprises at least one heat accumulator or heat absorber through which air flows and which is adapted to alternatively store/absorb and release heat energy. In the heat exchange material the major part of the heat is recovered and is used inter glia to heat the outdoor air for ventilation. The heat exchange material is preferably selected from the group consisting of ceramic or brick pieces, stone or fired clay gravel or pebbles, fired pellets of iron or other suitable high thermal capacity pelletized materials, conventional ceramic, metal or plastic packing of different shapes, corrugated metal or wire mesh. The heat exchange material may be provided as solids such as monolithic or preferably honeycomb-structure, foam or fiber materials.

In one preferred embodiment of the present invention the sorption material aluminum fumarate MOF is coated on a substrate showing the characteristics of the heat exchange material, preferably a ceramic substrate. Furthermore, the heat recovery adsorber may include solids impregnated with an adsorbent for water vapor and further sorbents. The further sorbents may be a sound-absorbing sorbent. Therefore, a combined heat exchanger module of sorptive type is provided. Preferably a thick, thermally well coupled and highly accessible coating of microporous aluminum fumarate MOF is deposited on a substrate, for example a ceramic or a metal substrate.

To enhance further the transfer of moisture between the two air streams a heater may be included. The heater may be operated periodically and/or during desorption period. The heater may be provided in the heat recovery adsorber, wherein heating wires or heating grids may be integrated in the filling of sorption material, i.e. integrated in a monolithic structure. Furthermore, quantity of shapes of the adsorbents for water vapors and/or further sorbents can be packed in pouches made of metallic tissue, which can be electrical heated. Air, heated in the at least one air fan unit can be used to heat the adsorbents.

In the ventilation system with the heat recovery adsorber at least one air fan unit is adapted so that it alternatively extracts and supplies air for the ventilation of the building or a room thereof. Preferably the at least one air fan unit comprises a reversible air fan unit, wherein a propeller operated by a reversible electric motor may be provided and secured to the housing. When the propeller rotates in one direction it draws air from outdoor through the components of the ventilation system, wherein the supply air may be forced through filter and sound-absorbing sorbent/damper units. When it rotates in the opposite direction it forces the exhaust air from inside through the device to the outdoor. Using the reversible air fan unit a controller may provide reversing the rotation of the air fan in equal time intervals, wherein the flow of the two air streams is periodic, countercurrent and balanced.

The ventilation system provides at least one filter unit for the incoming air to clean incoming air from particulates, odors and pollution in form of smoke, dust and/or pollen. To filter ambient air a fine filter should be used with a large surface area to allow long filter service life with a low pressure drop. Typically building filters employ activated, impregnated carbons for the removal of pollutants. Furthermore filter materials containing polyester or synthetic material or fiberglass or cotton/cellulose or metal mesh are known.

Furthermore, the ventilation system preferably comprises a sound-absorbing sorbent such as closed cellular or open-pore plastic foam, non-woven fabrics etc. A preferred material may be thermoplastic foam provided in monolithic form, including small channels with a diameter in the range of 5 to 10 mm and a free cross-section area for the flow of 70% up to 90% of the total cross-section area. The sound-absorbing sorbent may be provided with a thickness preferred in the range of 50 to 100 mm provided in a decentralized ventilation system or in the range of 300 to 700 mm provided in a centralized ventilation unit. Furthermore, since the noise of the at least one air fan unit is significant, the air fan unit may be mounted in soft foam to avoid solid-borne sound transfer.

A further aspect of the present invention refers to the use of a ventilation system for combined heat recovery, cooling/heating and dehumidifying/humidifying air streams for buildings.

Another aspect of the present invention is a method for the combined heat recovery, cooling/heating and dehumidifying/humidifying comprising the step of passing indoor and/or outdoor air streams through the ventilation system, wherein from the air streams heat and water vapor are regulated by the heat recovery adsorber.

Yet another aspect of the present invention is a building having a ventilation system as described herein.

The ventilation system with the heat recovery adsorber is preferably installed in buildings such that the heat recovery adsorber is near the inside, wherein the heat recovery adsorber has approximately room temperature. In winter season cold and dry outdoor air is drawn in and is heated by passing the heat recovery adsorber, and then humidified by the adsorbent for water vapor and entered the room with a temperature and humidity close to the values of the air in the room. Therefore the incoming air supplied to the inside does not reduce humidity in the ventilated rooms significantly.

In summer season warm humid outdoor air when passing through the heat recovery adsorber at least partly dehumidifies by transferring moisture to the adsorbent for water vapor and the released sorption heat is conveyed by the heated dehumidified air into the heat exchange material, which was cooled down by a preceded desorption period and has more or less room temperature which may be lower than the outdoor temperature. As the warm humid outdoor air is being cooled and dehumidified, the released sorption heat is being temporarily absorbed by the heat exchange material; the temperature is reduced closed to the temperature of the room air. During desorption period, the air from inside when passing through the heat recovery adsorber becomes humid by moisture released from the adsorbent for water vapor and is heated by transfer heat from the heat exchange material of the heat recovery adsorber. As the exhaust air is heated its capacity to remove moisture from the adsorbent for water vapor increases and consequently the moisture in the exhaust air increases while the moisture in the adsorbent for water vapor drops.

Exemplary embodiments of the invention are illustrated in the figures and are explained in greater details in the following description.

In the figures:

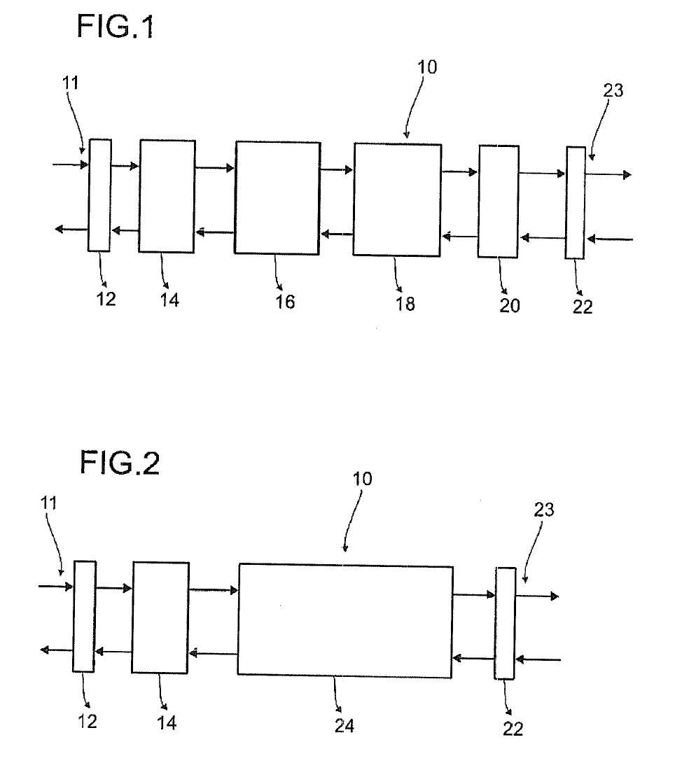

FIG. 1 shows an embodiment of a ventilation system with a heat recovery adsorber according to the invention;

FIG. 2 shows another embodiment of a ventilation system with a heat recovery adsorber according to the invention;

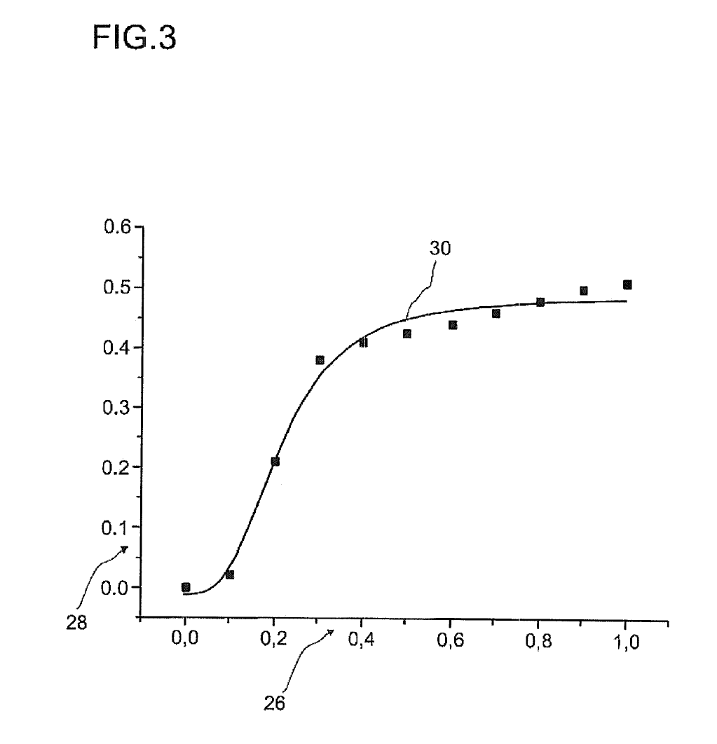

FIG. 3 shows water adsorption isotherms of a preferred adsorbent for water vapor BASOLITE® A520 used in an embodiment of a combined ventilation system according to the invention 298 K.

Referring to drawings, FIG. 1 shows a ventilation system 10 with a heat recovery adsorber in one preferred embodiment of the invention intended to be used in buildings, i.e. industrial, commercial and residential buildings, houses and mobile homes. As schematically indicated in FIG. 1 the ventilation system 10 comprises from outside to the inside of the building the following components: an exterior intake/outlet opening 11, a first filter unit 12, i.e. a dust filter, a air fan unit 14, for example a reversible air fan unit, heat exchange material 16, sorption material 18, sound-absorbing sorbent 20, a second filter unit 22 and an interior intake/outlet opening 23. In FIG. 1 a controller unit to control the rotation and direction of an electric motor operating the reversible air fan unit is not shown.

The reversible air fan unit 14 includes a housing attached to the following components, an axial type propeller and a reversible electric motor secured to the housing

When the air fan propeller rotates in one direction fresh air from the outside is sucked in and flows through the first filter unit 12, the following heat exchange material 16, sorption material 18, in the shown embodiment sound-absorbing sorbent 20 and the second filter unit 22, when it rotates in the opposite direction it forces the exhaust air from inside through the ventilation system to outdoor. Using a controller with the reversible air fan unit 14 the directions of the rotation can be reversed in equal time intervals, therefore the flow of the two air streams through the ventilation system 10 is periodic, countercurrent and balanced.

The ventilation system 10 comprises in the embodiment shown in FIG. 1 the first filter unit 12 and the second filter unit 22. According to a preferred embodiment the first filter unit 12 is a conventional filter for cleaning the incoming air from pollutants, dust, particulate matters and of odors etc. The second filter unit 22 may comprise a filter material to clean the air stream from pollens. Building filters typically employ activated impregnated carbons for the removal of pollutants, i.e. toxic chemicals. In filter units a sorbent is housed in a structure such that the toxic gas stream passes through a packed bad, monolith or volume such that the toxic gas contacts the sorbent and is removed by physical adsorption and/or chemical reaction.

According to the embodiment shown in FIG. 1 the heat exchange material 16, the sorption material 18 and the sound-absorbing sorbent 20 are arranged in separated components which are connected to one another in an appropriate way. The heat exchange material 16 is provided as a matrix in a casing with an opening for intake of exhaust air and an opening for outdoor fresh air and an opening for discharge of the exhaust air and for discharge of the fresh air. The matrix may include a single bed of solids or preferably a monolithic structure. Depending on the application, the matrix may include heat exchange material 16 such as ceramics.

The sorption material 18 includes at least an adsorbent for water vapor suitable for adsorbing moisture from the incoming fresh outdoor air wherein the water adsorption isotherm 30 of the adsorbent shows the characteristic s-shape form. During a sorption period the moisture from the incoming fresh outdoor air is adsorbed and is transferred into the exhaust air during desorption period. Furthermore moisture form exhaust air may adsorb on the adsorbent for water vapor and may desorb into incoming cool air. Said adsorbent for water vapor can be provided in different forms, alone or together with other sorbents of the sorption material 18. The sorption material 18 may be used as loose materials or as shaped bodies. The preferred metal-organic framework (MOF) may be used in form of granulates, shaped bodies or monolith. It is likewise to use mixtures of metal-organic framework (MOE) and other sorbents such as activated carbon, wherein mixtures of shaped bodies may be used too. The geometries of the shaped bodies are not subject to any restrictions. For example, possible shapes are, inter alia, pellets, pills, spheres, granules and extrudate such as rods, honeycombs, grids or hollow bodies. The sorption material 18 may be provided as monolith or in form of granulates attached to a substrate, for example a film permeable to air. The sorption material 18 may be provided as coating on a substrate or support. Furthermore the sorption material 18 may be provided as a matrix, including a heater for example in the form of heating wires.

The sound-absorbing sorbent 20 may include a noise-absorbing material, for example in the form of monolithic thermoplastic foam.

Since heat exchange material 16, sorption material 18 and sound-absorbing sorbent 20 may include structures or solids the preferred overall pressure drop has to be in the range of 1 mbar to 100 mbar.

Referring to FIG. 2, another embodiment of the ventilation system 10 with heat recovery adsorber is shown. In this embodiment the numbers of the comprised components are reduced by integrating different functions of the ventilation system 10 in a combined component 24. According to FIG. 2 the heat exchange material 16, the sorption material 18 and the sound-absorbing sorbent 20 are combined. Said combined component 24 may include the heat exchange material 16 provided as a matrix of ceramics and coated with the sorption material 18, for example the adsorbent for water vapor and/or the sound-absorbing sorbent 20. Furthermore, said combined component 24 may include monoliths, wherein a part is coated with a sound-absorbing sorbent 20 and another part is coated with the adsorbent for water vapor such as MOF, i.e. BASOLITE® A520.

Referring to FIG. 3, a water adsorption isotherm of the preferred adsorbent for water vapor BASOLITE® A520 is shown. The x-coordinate 26 represents the relative humidity, which is defined by the ratio of the partial pressure of water vapor to the saturation pressure of water vapor at the same temperature. The y-coordinate 28 represents the excess-uptake of the adsorbent for water vapor expressed in kg_{water}/kg_{adsorbent}. The preferred adsorbent BASOLITE® A520, based on aluminum fumarate MOF, exhibits typically s-shaped water adsorption isotherm 30 recorded at 298 K. The isotherm 30 shows in the relative humidity range <0.15 less adsorption, i.e. preferably less than approximately 0.10 kg_{water}/kg_{adsorbent}, and the favorable steep increase in a narrow region of the relative humidity from 0.15 to 0.4. The water uptake in this relative humidity range is approximately 80% of the total loading. The isotherm 30 reaches a saturation plateau with less pronounced adsorption in the relative humidity range >0.4, wherein the additional water uptake is in the range from 0.05 to 0.15 kg_{water}/kg_{adsorbent}. The total water uptake at 100% humidity for the preferred adsorbent for water vapor BASOLITE® A520 is approximately 0.55 kg_{water}/kg_{adsorbent}.

1.-16. (canceled)

17. A ventilation system (10) with heat recovery adsorber, the ventilation system (10) for being installed in buildings, wherein the ventilation system (10) furthermore comprises at least one exterior intake/outlet opening (11) for an air stream from outside of the building and at least one interior intake/outlet opening (23) for an air stream from inside of the building, at least one air fan unit (14) and at least one filter unit (12, 22), wherein the heat recovery adsorber includes a heat exchange material (16) for absorbing and releasing heat from the air streams and a sorption material (18) for at least adsorbing and desorbing at least one sorbate from the air streams, wherein the at least one sorbate is water vapor, said sorption material (18) comprising at least one adsorbent for water vapor exhibiting an s-shaped water adsorption isotherm (30) at room temperature (25° C.+/−10° C.) with a steep increase in a narrow relative humidity range, wherein a main loading lift of the adsorbent for water vapor occurs in the relative humidity range from 0.1 to 0.5 and the saturation capacity lies in the range from 0.25 to 1.2 kg_{water}/kg_{adsorbent}.

18. The ventilation system (10) according to claim 17, wherein the steep increase of the water adsorption isotherm (30) is in the relative humidity range from 0.15 to 0.4.

19. The ventilation system (10) according to claim 17, wherein the saturation capacity of the adsorbent for water vapor lies in the range from 0.3 to 0.6 kg_{water}/kg_{adsorbent}.

20. The ventilation system (10) according to claim 17, wherein the loading lift is at least 65% of the total loading.

21. The ventilation system (10) according to claim 17, wherein the adsorbent for water vapor is selected from the group consisting of silica gels, activated alumina, activated bauxite, molecular sieves and metal-organic frameworks (MOFs).

22. The ventilation system (10) according to claim 17, wherein the sorption material (18) is provided as pulverulent material, granulates, shaped bodies or monoliths and arranged in a casing as a matrix or a filling such as a packed bed or a moving bed and preferably as monolith.

23. The ventilation system (10) according to claim 17, wherein the sorption material (18) is deposited as a coating on a substrate, preferably made of ceramic, metal, plastic, foam based on polyurethane, polypropylene, polyester, metal or ceramic, woven or non-woven fibers of plastic, cellulose or mixtures thereof.

24. The ventilation system (10) according to claim 17, wherein the sorption material (18) is a metal-organic framework (MOF), preferably as aluminum fumarate MOF.

25. The ventilation system (10) according to claim 17, wherein the heat exchange material (16) is selected from the group consisting of ceramic or brick pieces, stone or fired clay gravel or pebbles, fired pellets of iron or other suitable high thermal capacity pelletized materials, conventional ceramic, metal or plastic packing of different shapes, corrugated metal and wire mesh.

26. The ventilation system (10) according to claim 17, wherein the heat exchange material (16) is provided as a honeycomb-structure.

27. The ventilation system (10) according to claim 23, wherein the coating comprises aluminum fumarate MOF deposited on a ceramic substrate.

28. The ventilation system (10) according to claim 17, wherein the sorption material (18) further comprises a sound-absorbing sorbent (20).

29. The ventilation system (10) according to claim 17, wherein the ventilation system (10) is provided as a decentralized unit, preferably installed in separated rooms of the building or as a centralized unit, installed in the building, wherein air from inside of the building is led to the interior intake/outlet opening (23) and the exterior intake/outlet opening (11) is arranged on an envelope of the building.

30. A method for combined heat recovery, cooling/heating and dehumidifying/humidifying air streams for buildings comprising the step
passing indoor and/or outdoor air streams through a ventilation system (10) according to claim 17, wherein from the air streams heat and water vapor are regulated by the heat recovery adsorber.

31. A building having a ventilation system (10) according to claim 17.

32. Method of using a ventilation system (10) according to claim 17 for combined heat recovery, cooling/heating and dehumidifying/humidifying of air streams for buildings.
